(19) United States
(12) Patent Application Publication
(10) Pub. No.: US 2012/0177104 A1
(43) Pub. Date: Jul. 12, 2012

(54) Reduced Complexity Adaptive Loop Filter (ALF) for Video Coding

(76) Inventors: Madhukar Budagavi, Plano, TX (US); Minhua Zhou, Plano, TX (US); Vivienne Sze, Dallas, TX (US)

(21) Appl. No.: 13/348,583

(22) Filed: Jan. 11, 2012

Related U.S. Application Data
(60) Provisional application No. 61/431,892, filed on Jan. 12, 2011.
(60) Provisional application No. 61/451,502, filed on Mar. 10, 2011.
(60) Provisional application No. 61/534,209, filed on Sep. 13, 2011.
(60) Provisional application No. 61/559,937, filed on Nov. 15, 2011.

(51) Int. Cl. H04N 7/26

(52) U.S. Cl. 375/240.02; 375/E07.176; 375/E07.027

(57) ABSTRACT

Methods and apparatus for adaptive loop filtering in video coding are provided. The adaptive loop filtering may be largest coding unit (LCU) based, may use adaptive loop filter types in which the vertical size of a filter type is less than the horizontal size, may use a predefined set of filter types in which the vertical size of the largest filter type in the set is less than the horizontal size of the largest filter type in the set, may use a single adaptive loop filter type, and/or may use a filter type that is a cross with a center shape of a size dependent on an aspect ratio of the cross.

### CROSS-REFERENCE TO RELATED APPLICATIONS

This application claims benefit of U.S. Provisional Patent Application Ser. No. 61/431,892, filed Jan. 12, 2011, U.S. Provisional Patent Application Ser. No. 61/451,502, filed Mar. 10, 2011, U.S. Provisional Patent Application Ser. No. 61/534,209, filed Sep. 13, 2011, and U.S. Provisional Patent Application Ser. No. 61/559,937, filed Nov. 15, 2011, all of which are incorporated herein by reference in their entirety.

### BACKGROUND OF THE INVENTION

1. Field of the Invention

Embodiments of the present invention generally relate to adaptive loop filtering in video coding.

2. Description of the Related Art

Video compression, i.e., video coding, is an essential enabler for digital video products as it enables the storage and transmission of digital video. In general, video compression techniques apply prediction, transformation, quantization, and entropy coding to sequential blocks of pixels in a video sequence to compress, i.e., encode, the video sequence. Video decompression techniques generally perform the inverse of these operations in reverse order to decompress, i.e., decode, a compressed video sequence.

The Joint Collaborative Team on Video Coding (JCT-VC) of ITU-T WP3/16 and ISO/IEC JTC 1/SC 29/WG 11 is currently developing the next-generation video coding standard referred to as High Efficiency Video Coding (HEVC). HEVC is expected to provide around 50% improvement in coding efficiency over the current standard, H.264/AVC, as well as larger resolutions and higher frame rates. To address these requirements, HEVC utilizes larger block sizes then H.264/AVC. In HEVC, the largest coding unit (LCU) can be up to 64×64 in size, while in H.264/AVC, the macroblock size is fixed at 16×16.

Adaptive loop filtering (ALF) is a new coding tool that has been introduced into HEVC. In general, ALF is an adaptive Wiener filtering technique applied after the deblocking filter to improve the reference picture used for encoding/decoding of subsequent pictures. The original ALF concept is explained in more detail in Y. Chiu and L. Xu, “Adaptive (Wiener) Filter for Video Compression,” ITU-T SG16 Contribution, C437, Geneva, CH, April 2008. As originally proposed, ALF used square filters and was carried out on entire deblocked pictures. Subsequently, block-based adaptive loop filtering was proposed in which ALF could be enabled and disabled on a block, i.e., coding unit, basis. In block-based ALF, the encoder signals to the decoder the map of blocks of a deblocked picture on which ALF is to be applied. Block-based ALF is described in more detail in T. Chujoh, et al., “Block-based Adaptive Loop Filter,” ITU-T SG16 Q.6 Document, VCEG-A118, Berlin, Del., July 2008.

A further refinement to block-based ALF, quadtree adaptive loop filtering, was subsequently proposed in which the map of blocks was signaled using a quadtree. Quad-tree ALF is described in more detail in T. Chujoh, et al., “Quadtree-based Adaptive Loop Filter,” ITU-T SG16 Contribution, C181, January 2009. The use of diamond shaped rather than square shaped ALF filters was then proposed to reduce computational complexity. Diamond shaped ALF filters for luma components are described in more detail in M. Karczewicz, et. al., “A Hybrid Video Coder Based on Extended Macroblock Sizes, Improved Interpolation, and Flexible Motion Representation,” IEEE Trans. on Circuits and Systems for Video Technology, pp. 1698-1708, Vol. 20, No. 12, December 2010, “Karczewicz” herein.

### SUMMARY

Embodiments of the present invention relate to methods and apparatus for adaptive loop filtering in video coding. In one aspect, a method for decoding an encoded video bit stream in a video decoder is provided that includes decoding a plurality of sets of adaptive loop filter coefficients encoded in the video bit stream, and decoding a picture encoded in the video bit stream, wherein adaptive loop filtering is applied to the decoded picture on a largest coding unit (LCU) by LCU basis according to an adaptive loop filter type used in encoding the picture and the plurality of sets of adaptive loop filter coefficients.

In one aspect, a method for decoding an encoded video bit stream in a video decoder is provided that includes decoding a plurality of sets of adaptive loop filter coefficients encoded in the video bit stream, and decoding a picture encoded in the video bit stream, wherein adaptive loop filtering is applied to the decoded picture according to an adaptive loop filter type used in encoding the picture and the plurality of sets of adaptive loop filter coefficients, wherein there is only one adaptive loop filter type.

In one aspect, a method for decoding an encoded video bit stream in a video decoder is provided that includes decoding a plurality of sets of adaptive loop filter coefficients encoded in the video bit stream, and decoding a picture encoded in the video bit stream, wherein adaptive loop filtering is applied to the decoded picture according to an adaptive loop filter type used in encoding the picture and the plurality of sets of adaptive loop filter coefficients, wherein a vertical size of the adaptive loop filter type is smaller than a horizontal size of the adaptive loop filter type.

### BRIEF DESCRIPTION OF THE DRAWINGS

Particular embodiments will now be described, by way of example only, and with reference to the accompanying drawings:

FIG. 1 shows prior art diamond-shaped ALF filter types;

FIG. 2 is a block diagram of a digital system;

FIG. 3 is a block diagram of a video encoder;

FIG. 4 is a block diagram of a video decoder;

FIG. 5 is an example of applying ALF to largest coding units (LCUs);

FIGS. 6-14 are examples of ALF filter types;

FIGS. 15 and 16 are flow diagrams of methods for LCU-based adaptive loop filtering; and

FIG. 17 is a block diagram of an illustrative digital system.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As used herein, the term “picture” may refer to a frame or a field of a frame. A frame is a complete image captured during a known time interval. For convenience of description, embodiments of the invention are described herein in reference to HEVC. One of ordinary skill in the art will understand that embodiments of the invention are not limited to HEVC. In HEVC, a largest coding unit (LCU) is the base unit used for block-based coding. A picture is divided into non-overlapping LCUs. That is, an LCU plays a similar role in coding as the macroblock of H.264/AVC, but it may be larger, e.g., 32×32, 64×64, etc. An LCU may be partitioned into coding units (CU). A CU is a block of pixels within an LCU and the CUs within an LCU may be of different sizes. The partitioning is a recursive quadtree partitioning. The quadtree is split according to various criteria until a leaf is reached, which is referred to as the coding node or coding unit. The maximum hierarchical depth of the quadtree is determined by the size of the smallest CU (SCU) permitted. The coding node is the root node of two trees, a prediction tree and a transform tree. A prediction tree specifies the position and size of prediction units (PU) for a coding unit. A transform tree specifies the position and size of transform units (TU) for a coding unit. A transform unit may not be larger than a coding unit and the size of a transform unit may be 4×4, 8×8, 16×16, and 32×32. The sizes of the transforms units and prediction units for a CU are determined by the video encoder during prediction based on minimization of rate/distortion costs.

Some aspects of this disclosure have been presented to the JCT-VC in the following documents: JCTVC-D039, entitled “ALF Decode Complexity Analysis and Reduction”, Jan. 20-28, 2011, JCTVC-E060, entitled “CE8 Subtest 5: Luma ALF with Reduced Vertical Filter Size”, Mar. 16-23, 2011, JCTVC-E287, entitled “Chroma ALF with Reduced Vertical Filter Size”, Mar. 16-23, 2011, JCTVC-F234, entitled “CE8, Subset 4, Tool 3: ALF Decode with Reduced Vertical Filter Size”, Jul. 14-22, 2011, JCTVC-F235, entitled “CE8, Subset 5, Tool 3: Chroma ALF with Reduced Vertical Filter Size”, Jul. 14-22, 2011, JCTVC-G130, entitled “CE8 Subtest d—Chroma ALF with Reduced Vertical Filter Size, Nov. 21-30, 2011, and JCTVC-G813, entitled ALF with Single Filter Type, Nov. 21-30, 2011. These documents are incorporated by reference herein in their entirety. Some aspects of this disclosure are also described in M. Budagavi, et al., “HEVC ALF Decode Complexity Analysis and Reduction,” IEEE International Conference on Image Processing, pp. 733-736, Brussels, Belgium, September 2011, “Budagavi” herein, which is incorporated by reference herein in its entirety.

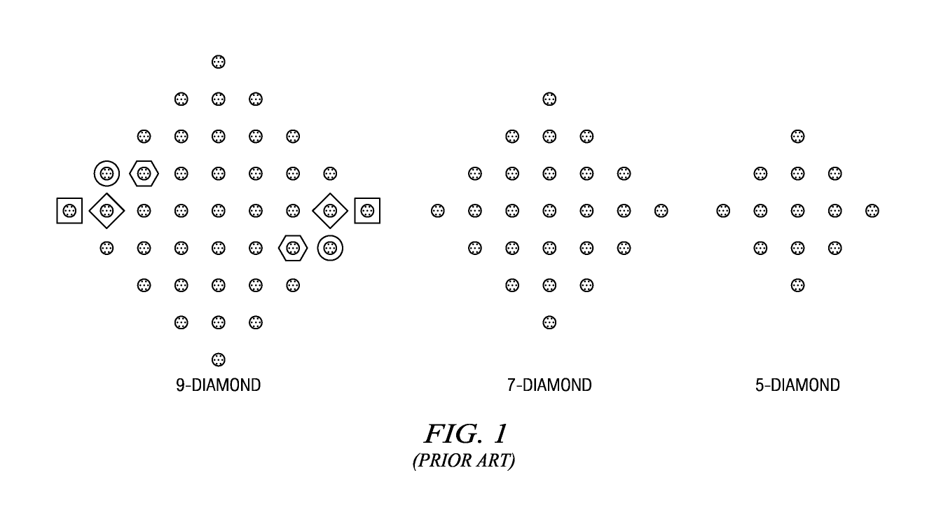

As previously discussed, adaptive loop filtering (ALF) is a new coding tool proposed in HEVC. The ALF for luma components in the first version of the HEVC Test Model (HM 1.0) is based on the filter presented in Karczewicz and uses a set of three filter types: diamond shaped filter types of sizes 9, 7, and 5 as shown in FIG. 1 and the ALF for chroma components uses square kernels. The ALF for both luma and chroma components is picture-based and the filter type is allowed to change for each picture, but the same filter type is used within a picture. Further, filtering may be selectively applied to blocks within each picture. Quadtree based signaling is used to specify which blocks are to be filtered.

In the encoder, all filter types in the set of filter types are considered for each picture and one is selected. Up to sixteen different sets of filter coefficients can be used for each picture. The sets of filter coefficients used for the ALF can also change for every picture. Accordingly, the sets of filter coefficients, the filter type, and the ALF enable map, i.e., the quadtree, are signaled at a picture level, i.e., up to sixteen sets of coefficients, the filter type, and the ALF enable map are sent to the decoder for every picture. At the decoder, a Laplacian-based local activity is used to switch between the different filter coefficients on a block-by-block basis.

Each of the filter types has 180-degree rotation symmetry as indicated in the 9-Diamond filter type in FIG. 1 in which coefficients in similar shaped boxes are equal. While only a few boxes have been used in FIG. 1 to illustrate the type of symmetry, all the coefficients in the filter type are in fact symmetric. As a result, a filter type of size N requires (N*N/4+1) multiplications. For size 9 filter type, this translates to 21 multiplications. If no buffering of previously read pixels is employed, the number of pixels that need to be read from memory to carry out one filtering operation is 41. The memory bandwidth needed, with its attendant impact on processing speed and power consumption, may not be practical for embedded systems in mobile battery operated devices. The number of pixels to be read can be reduced by buffering deblocked pixels horizontally and/or vertically. Such buffering is described, for example, in JCTVC-D039 and JCTVC-E060. However, the memory bandwidth needed may still not be practical for resource constrained devices.

Embodiments of the invention provide for reducing the memory bandwidth and computational requirements of ALF. In some embodiments, ALF is LCU-based rather than picture-based. That is, rather than waiting until an entire picture has been processed through the block-based encoding (or decoding) and the deblocking filter before applying ALF to the picture as in HM 1.0, ALF is applied on an LCU by LCU basis. In some embodiments, ALF filter types in which the vertical size of a filter type is less than the horizontal size are used. Further, the number of filter types in the predefined set of filter types may vary, e.g., the number of filter types may be 3, 2, or 1.

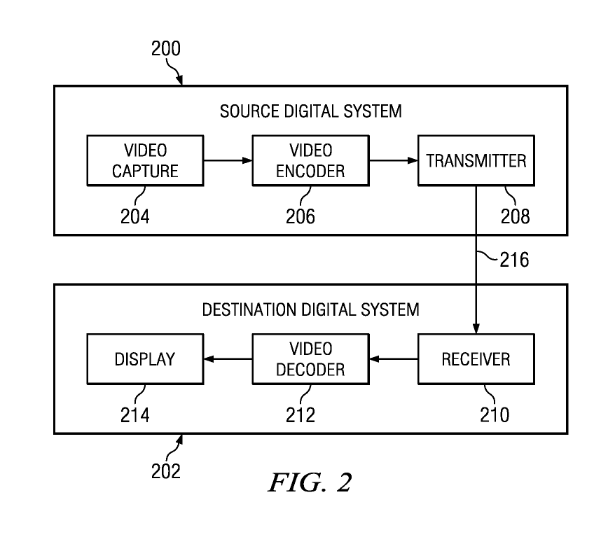

FIG. 2 shows a block diagram of a digital system that includes a source digital system 200 that transmits encoded video sequences to a destination digital system 202 via a communication channel 216. The source digital system 200 includes a video capture component 204, a video encoder component 206, and a transmitter component 208. The video capture component 204 is configured to provide a video sequence to be encoded by the video encoder component 206. The video capture component 204 may be, for example, a video camera, a video archive, or a video feed from a video content provider. In some embodiments, the video capture component 204 may generate computer graphics as the video sequence, or a combination of live video, archived video, and/or computer-generated video.

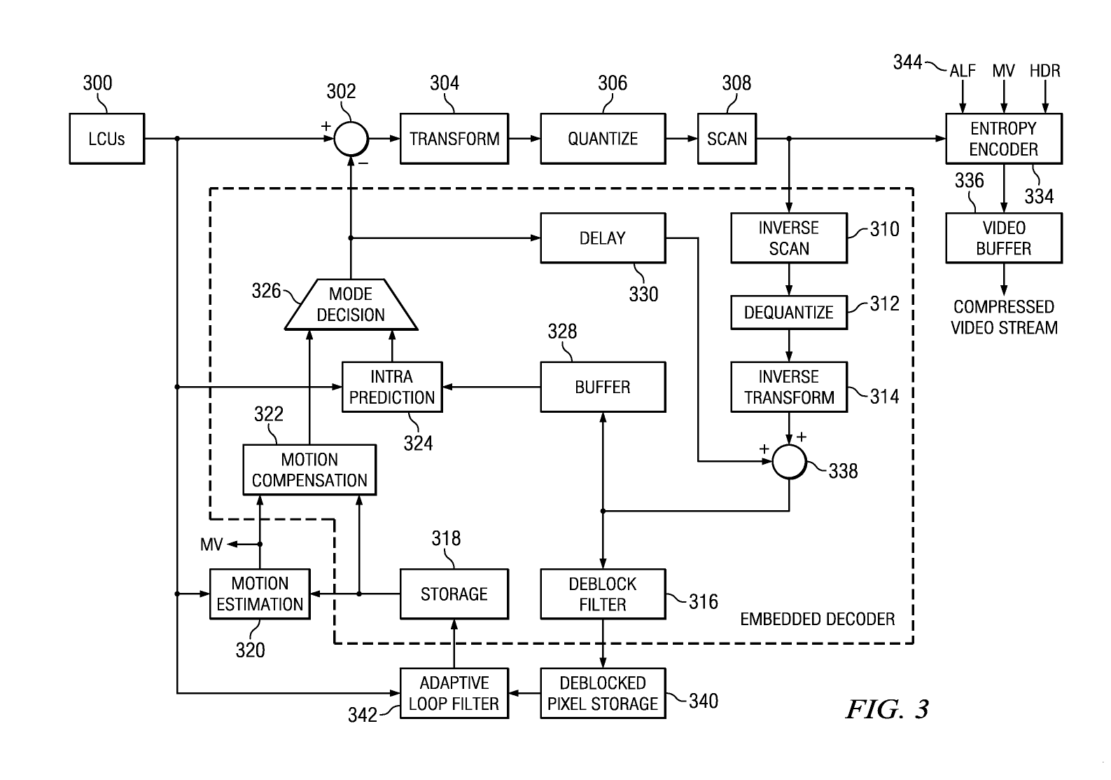

The video encoder component 206 receives a video sequence from the video capture component 204 and encodes it for transmission by the transmitter component 208. The video encoder component 206 receives the video sequence from the video capture component 204 as a sequence of pictures, divides the pictures into largest coding units (LCUs), and encodes the video data in the LCUs. The video encoder component 206 may be configured to apply adaptive loop filtering techniques during the encoding process as described herein. An embodiment of the video encoder component 206 is described in more detail herein in reference to FIG. 3.

The transmitter component 208 transmits the encoded video data to the destination digital system 202 via the communication channel 216. The communication channel 216 may be any communication medium, or combination of communication media suitable for transmission of the encoded video sequence, such as, for example, wired or wireless communication media, a local area network, or a wide area network.

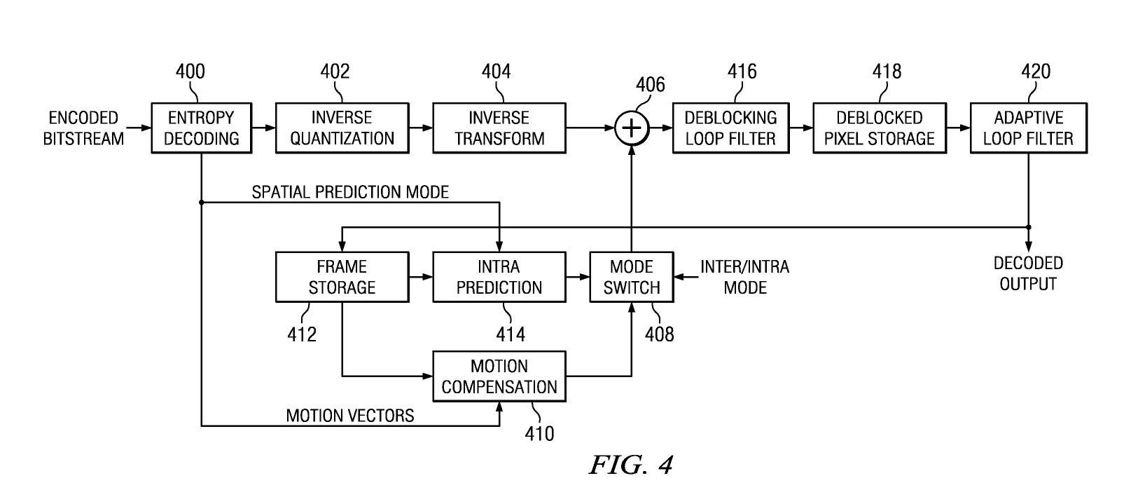

The destination digital system 202 includes a receiver component 210, a video decoder component 212 and a display component 214. The receiver component 210 receives the encoded video data from the source digital system 200 via the communication channel 216 and provides the encoded video data to the video decoder component 212 for decoding. The video decoder component 212 reverses the encoding process performed by the video encoder component 206 to reconstruct the LCUs of the video sequence. The video decoder component 212 may be configured to apply adaptive loop filtering techniques during the decoding process as described herein. An embodiment of the video decoder component 212 is described in more detail below in reference to FIG. 4.

The reconstructed video sequence is displayed on the display component 214. The display component 214 may be any suitable display device such as, for example, a plasma display, a liquid crystal display (LCD), a light emitting diode (LED) display, etc.

In some embodiments, the source digital system 200 may also include a receiver component and a video decoder component and/or the destination digital system 202 may include a transmitter component and a video encoder component for transmission of video sequences both directions for video steaming, video broadcasting, and video telephony. Further, the video encoder component 206 and the video decoder component 212 may perform encoding and decoding in accordance with one or more video compression standards. The video encoder component 206 and the video decoder component 212 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIG. 3 shows a block diagram of the LCU processing portion of an example video encoder. A coding control component (not shown) sequences the various operations of the LCU processing, i.e., the coding control component runs the main control loop for video encoding. The coding control component receives a digital video sequence and performs any processing on the input video sequence that is to be done at the picture level, such as determining the coding type (I, P, or B) of a picture based on the high level coding structure, e.g., IPPP, IBBP, hierarchical-B, and dividing a picture into LCUs for further processing. The coding control component also may determine the initial LCU CU structure for each CU and provides information regarding this initial LCU CU structure to the various components of the video encoder as needed. The coding control component also may determine the initial PU and TU structure for each CU and provides information regarding this initial structure to the various components of the video encoder as needed.

The LCU processing receives LCUs of the input video sequence from the coding control component and encodes the LCUs under the control of the coding control component to generate the compressed video stream. The CUs in the CU structure of an LCU may be processed by the LCU processing in a depth-first Z-scan order. The LCUs 300 from the coding control unit are provided as one input of a motion estimation component 320, as one input of an intra prediction component 324, and to a positive input of a combiner 302 (e.g., adder or subtractor or the like). Further, although not specifically shown, the prediction mode of each picture as selected by the coding control component is provided to a mode selector component and the entropy encoder 334.

The storage component 318 provides reference data to the motion estimation component 320 and to the motion compensation component 322. The reference data may include one or more previously encoded and decoded CUs, i.e., reconstructed CUs.

The motion estimation component 320 provides motion estimation information to the motion compensation component 322 and the entropy encoder 334. More specifically, the motion estimation component 320 performs tests on CUs in an LCU based on multiple inter prediction modes and transform block sizes using reference data from storage 318 to choose the best motion vector(s)/prediction mode based on a coding cost. To perform the tests, the motion estimation component 320 may begin with the CU structure provided by the coding control component 340. The motion estimation component 320 may divide each CU indicated in the CU structure into PUs according to the unit sizes of prediction modes and into transform units according to the transform block sizes and calculate the coding costs for each prediction mode and transform block size for each CU.

For coding efficiency, the motion estimation component 320 may also decide to alter the CU structure by further partitioning one or more of the CUs in the CU structure. That is, when choosing the best motion vectors/prediction modes, in addition to testing with the initial CU structure, the motion estimation component 320 may also choose to divide the larger CUs in the initial CU structure into smaller CUs (within the limits of the recursive quadtree structure), and calculate coding costs at lower levels in the coding hierarchy. If the motion estimation component 320 changes the initial CU structure, the modified CU structure is communicated to other components in the LCU processing component 342 that need the information.

The motion estimation component 320 provides the selected motion vector (MV) or vectors and the selected prediction mode for each inter predicted PU of a CU to the motion compensation component 323 and the selected motion vector (MV) to the entropy encoder 334. The motion compensation component 322 provides motion compensated inter prediction information to the mode decision component 326 that includes motion compensated inter predicted PUs, the selected inter prediction modes for the inter predicted PUs, and corresponding transform block sizes. The coding costs of the inter predicted PUs are also provided to the mode decision component 326.

The intra prediction component 324 provides intra prediction information to the mode decision component 326 that includes intra predicted PUs and the corresponding intra prediction modes. That is, the intra prediction component 324 performs intra prediction in which tests based on multiple intra prediction modes and transform unit sizes are performed on CUs in an LCU using previously encoded neighboring PUs from the buffer 328 to choose the best intra prediction mode for each PU in the CU based on a coding cost. To perform the tests, the intra prediction component 324 may begin with the CU structure provided by the coding control component 340. The intra prediction component 324 may divide each CU indicated in the CU structure into PUs according to the unit sizes of the intra prediction modes and into transform units according to the transform block sizes and calculate the coding costs for each prediction mode and transform block size for each PU.

For coding efficiency, the intra prediction component 324 may also decide to alter the CU structure by further partitioning one or more of the CUs in the CU structure. That is, when choosing the best prediction modes, in addition to testing with the initial CU structure, the intra prediction component 324 may also chose to divide the larger CUs in the initial CU structure into smaller CUs (within the limits of the recursive quadtree structure), and calculate coding costs at lower levels in the coding hierarchy. If the intra prediction component 324 changes the initial CU structure, the modified CU structure is communicated to other components in the LCU processing component 342 that need the information. Further, the coding costs of the intra predicted PUs and the associated transform block sizes are also provided to the mode decision component 326.

The mode decision component 326 selects between the motion-compensated inter predicted PUs from the motion compensation component 322 and the intra predicted PUs from the intra prediction component 324 based on the coding costs of the PUs and the picture prediction mode provided by the mode selector component. The output of the mode decision component 326, i.e., the predicted PU, is provided to a negative input of the combiner 302 and to a delay component 330. The associated transform block size is also provided to the transform component 304. The output of the delay component 330 is provided to another combiner (i.e., an adder) 338. The combiner 302 subtracts the predicted PU from the current PU to provide a residual PU to the transform component 304. The resulting residual PU is a set of pixel difference values that quantify differences between pixel values of the original PU and the predicted PU.

The transform component 304 performs block transforms on the residual PUs to convert the residual pixel values to transform coefficients and provides the transform coefficients to a quantize component 306. The transform component 304 receives the transform block sizes for the residual PUs and applies transforms of the specified sizes to the PUs to generate transform coefficients.

The quantize component 306 quantizes the transform coefficients based on quantization parameters (QPs) and quantization matrices provided by the coding control component and the transform sizes. The quantized transform coefficients are taken out of their scan ordering by a scan component 308 and arranged by significance, such as, for example, beginning with the more significant coefficients followed by the less significant.

The ordered quantized transform coefficients for a PU provided via the scan component 308 along with header information for the PU are coded by the entropy encoder 334, which provides a compressed bit stream to a video buffer 336 for transmission or storage. The header information may include the prediction mode used for the PU. The entropy encoder 334 also codes the CU structure of each LCU. The entropy encoder 334 also codes the ALF filter size, filter coefficients, and filtering structure for each picture.

The LCU processing includes an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent pictures. To determine the reconstructed input, i.e., reference data, the ordered quantized transform coefficients for a CU provided via the scan component 308 are returned to their original post-transform arrangement by an inverse scan component 310, the output of which is provided to a dequantize component 312, which outputs a reconstructed version of the transform result from the transform component 304.

The dequantized transform coefficients are provided to the inverse transform component 314, which outputs estimated residual information which represents a reconstructed version of a residual PU. The inverse transform component 314 receives the transform block size used to generate the transform coefficients and applies inverse transform(s) of the specified size to the transform coefficients to reconstruct the residual values.

The reconstructed residual PU is provided to the combiner 338. The combiner 338 adds the delayed selected PU to the reconstructed residual PU to generate an unfiltered reconstructed PU, which becomes part of reconstructed picture information. The reconstructed picture information is provided via a buffer 328 to the intra prediction component 324 and to a deblock filter component 316. The deblock filter component 316 filters the reconstructed picture information to alleviate blocking artifacts cased by the block-based video coding. The deblocking filter component 316 may, for example, adaptively apply low-pass filters to block boundaries according to the boundary strength. The filtered reference data is provided to the deblocked pixel storage component 340.

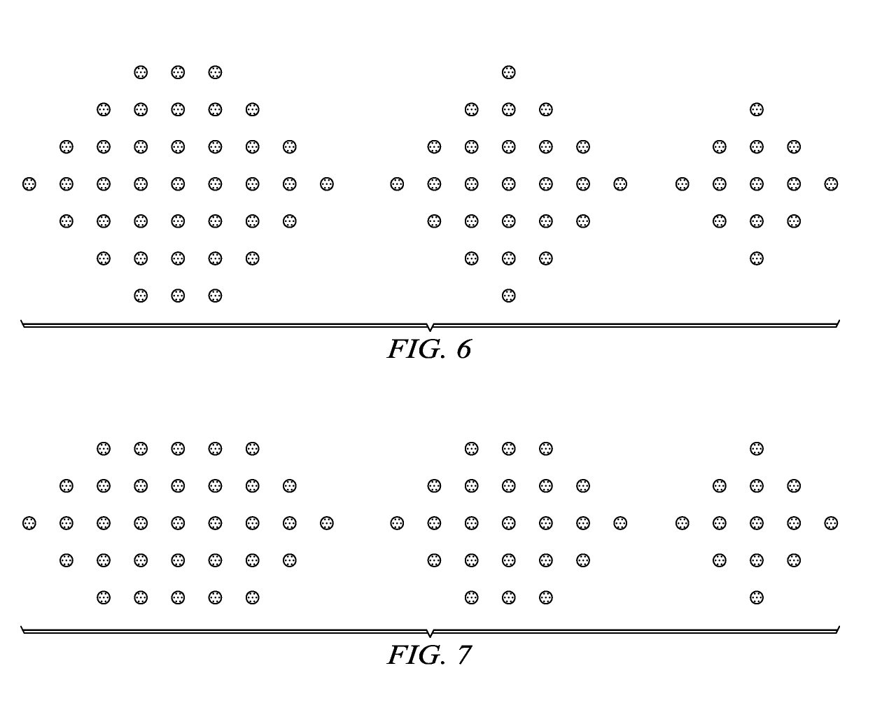

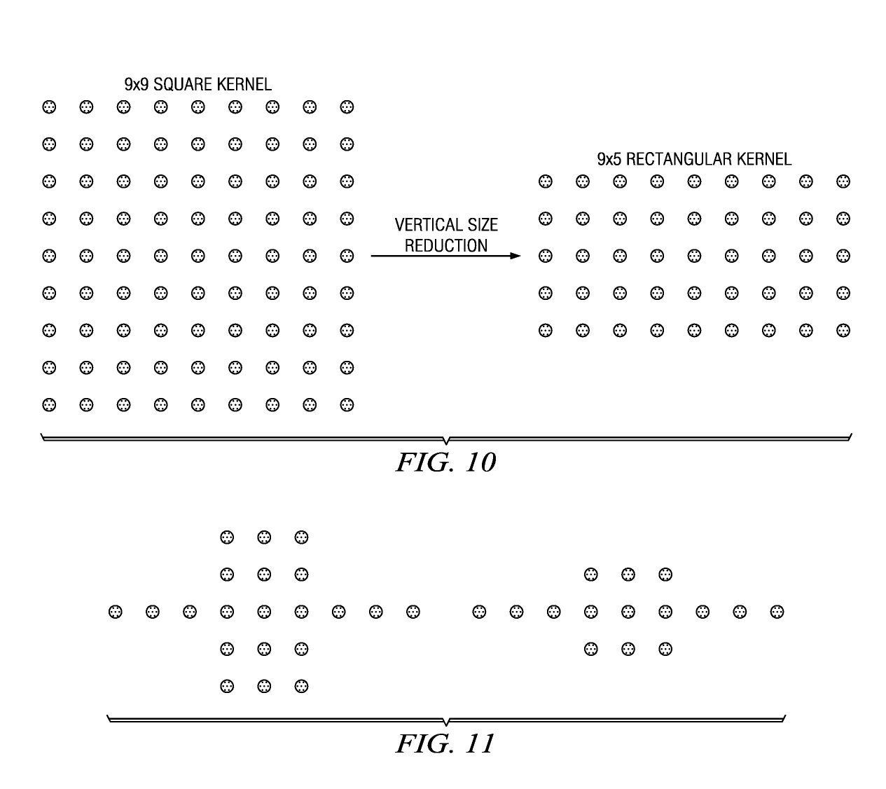

The adaptive loop filter component 342 performs adaptive loop filtering on the deblocked reference data and provides the final filtered reference data to the storage component 318. The adaptive loop filter component 342 initially adaptively estimates a set of filters for a reconstructed picture. That is, given a predefined set of filter types, the adaptive loop filter component 342 tests each filter type in the predefined set to determine which filter type is best for the reconstructed picture. A filter type specifies the size, i.e., number of taps, and shape, i.e., the relative positions of the taps with respect to the pixel to be filtered, of a filter. Further, each filter type has 180-degree rotation symmetry. FIGS. 6-14 show some example filter types.

The testing may include generating multiple sets of coefficients for each filter type in the predefined set. The filter coefficients may be estimated using the well-known Wiener filter estimation process by computing the auto-correlation of the deblocked reference data and the cross-correlation of the deblocked reference data and the original input data. Accordingly, the adaptively estimated set of filters may be one or more sets of filter coefficients for a filter type selected from the predefined set of filter types. The selection of the filter type and the set(s) of coefficients may be performed in any suitable way. In some embodiments, up to 16 sets of filter coefficients may be selected. The selected filter type, the set(s) of coefficients, and the ALF enable map are provided 344 to the entropy encoder 334.

Once a filter type and the set(s) of filter type coefficients for a reconstructed picture are determined, the adaptive loop filter component 342 applies adaptive loop filtering to the reconstructed picture on an LCU by LCU basis according to the filter type and the set(s) of filter coefficients.

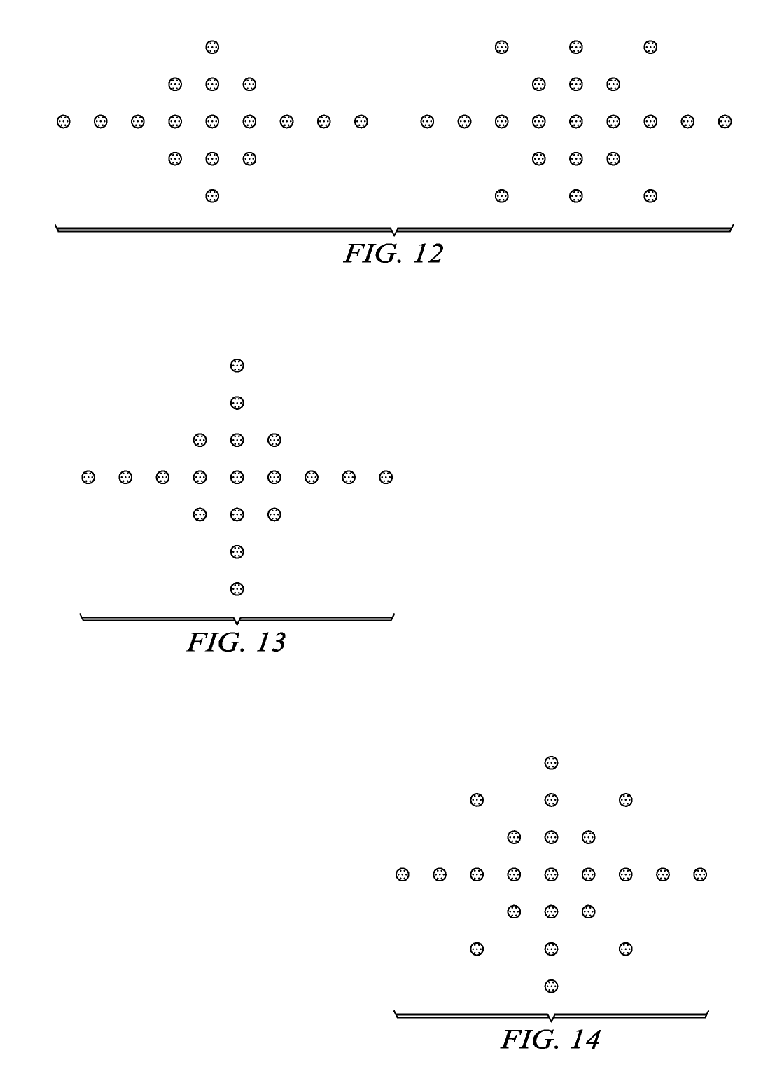

The number of filter types in the predefined set may vary in embodiments. In some embodiments, the predefined set includes three filter types. FIGS. 6-9 show examples of predefined set with three filter types. In some embodiments, the predefined set includes two filter types. FIGS. 11 and 12 shows examples of predefined sets with two filter types. In some embodiments, the predefined set includes only one filter type. FIGS. 13 and 14 shows examples of predefined sets with one filter type. Note that in the latter embodiments, there would be no need to signal the filter type to the decoder. In some embodiments, the predefined set may include more than three filter types.

As was previously mentioned, the adaptive loop filter component 342 applies filtering on an LCU basis instead of on a picture basis as in the prior art. Accordingly, not all pixels needed for filtering pixels at the right and/or bottom of an LCU will be available when the LCU is processed in the adaptive loop filter component 342. Any suitable technique may be used to allow for application of a filter when some of the required pixel values are not available. For example, default values may be used for the missing pixel values or values of other available pixels may be replicated.

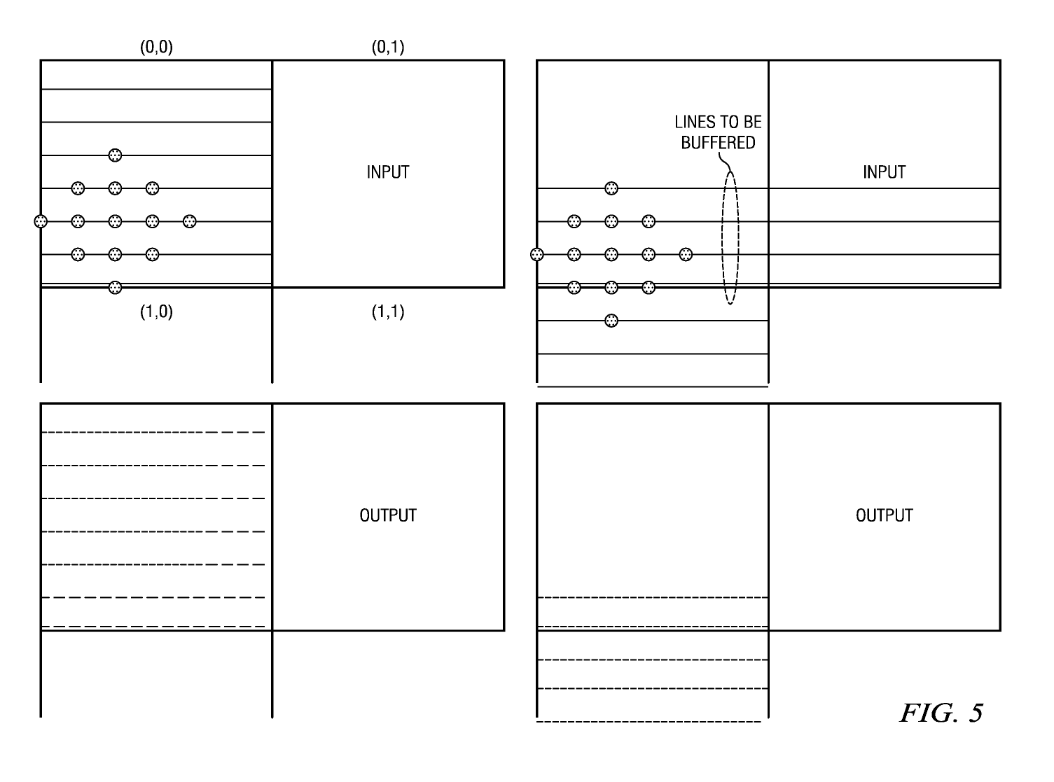

FIG. 5 shows a simple example of one technique that may be used to filter an LCU when pixel values are not available. In this example, four LCUs are assumed, LCU (0,0), LCU (0,1), LCU (1,0), and LCU (1,1) as well as a 5×5 diamond filter shape. The dashed areas of LCU (0,0) in the lower left portion of FIG. 5 illustrate the pixels for which right and/or lower neighboring pixels are not available for application of the filter. For the particular filter shape, these pixels include the bottom two rows of the LCU and the last two pixels in each row. These pixels may be temporarily stored and filtered when the unavailable pixels are available. Note that, as illustrated in the upper left portion of FIG. 5, for LCU (0, 1), the pixels needed to filter the bottom two rows of the LCU will also not be available. Further, in order to be able to complete filtering of these two rows of pixels, the two rows of pixels above the unfiltered rows also need to be temporarily stored. Accordingly, for the particular filter shape, four rows of pixels would need to be stored. These rows of pixel may be stored, for example, in line buffers. Then, as shown in the bottom right portion of FIG. 5, when LCU (1.0) is processed, the unfiltered bottom two rows of LCU (0,0) can be filtered. Similarly, the bottom two rows of LCU (0,1) can be filtered when LCU (1, 1) is processed.

As can be recognized from this simple example, the amount of storage needed to retain the rows of unfiltered pixels and the additional rows of pixels needed for filter application depends on the maximum vertical filter size and the maximum picture width. Thus, decreasing the maximum vertical filter size will decrease the amount of storage needed. Further, even if an alternative technique for supplying values for unavailable pixels is used that does not involve storing rows of pixels, decreasing the maximum vertical filter size decreases the computational complexity and memory bandwidth of applying the larger filters.

Accordingly, in some embodiments, the maximum vertical size of the filter types in the predefined set of filter types is constrained to be at least less than the horizontal filter size of the largest filter type in the set. In some embodiments, the maximum vertical size may be less than the horizontal filter size of other filter types in the set. In the prior art, the filter types used, e.g., square shapes and diamond shapes, have equal horizontal and vertical size. FIGS. 6-9 and 11-14 show examples of filter type sets in which the maximum vertical size is constrained. In the example filter type sets of FIGS. 6-9, 11, and 12, the maximum vertical size of the filter types is constrained to be less than the horizontal size of the largest filter type in the set.

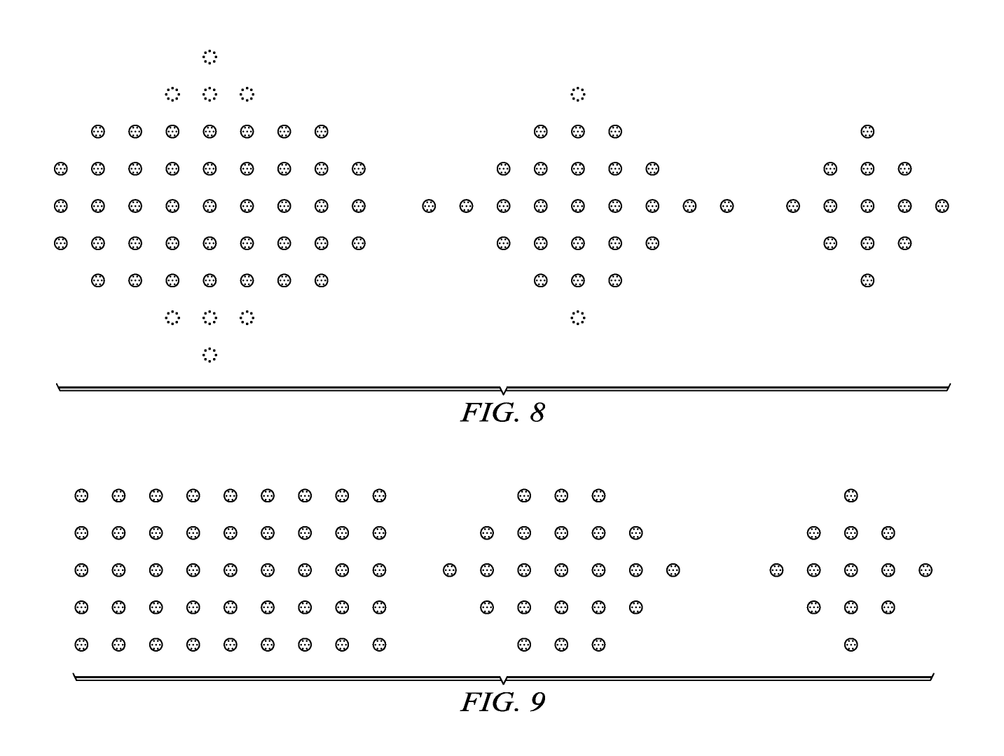

Experiments have shown that use of filter types with such vertical size constraints may provide similar filtering performance to the full-sized diamond or square filter types. For example, as described in JCTVC-D039, the N×5 filter type sets of FIG. 7 and FIG. 8 capture most of the ALF coding gains of the filter type set of FIG. 1. Also, as described in Budagavi, the N×7 filter type set of FIG. 6 also captures most of the ALF coding gains of the filter type set of FIG. 1. Note that in FIG. 6, the leftmost filter type is a 9×7 vertically flattened diamond and in FIG. 7, the leftmost filter type is a 9×5 vertically flattened diamond, and the center filter type is a 7×5 vertically flattened diamond.

In some embodiments, the filter types may be based on kernels with reduced vertical size other than the diamond and square kernels of the prior art. Examples of such filter types are shown in FIGS. 11-14. In FIG. 11, the filter type on the left is a 9×5 cross with a center 3×5 rectangle and the filter type on the right is a 9×3 cross with a center 3×3 square. In FIG. 12, the filter type on the left is a 9×5 cross with a center 3×3 square and the filter type on the left is a 9×5 cross with a center 5×5 square. In FIG. 13, the filter type is a 9×7 cross with a 3×3 center square. In FIG. 14, the filter type is a 9×7 cross with a 5×5 center star.

FIG. 4 shows a block diagram of an example video decoder. The video decoder operates to reverse the encoding operations, i.e., entropy coding, quantization, transformation, and prediction, performed by the video encoder of FIG. 3 to regenerate the pictures of the original video sequence. In view of the above description of a video encoder, one of ordinary skill in the art will understand the functionality of components of the video decoder without detailed explanation.

The entropy decoding component 400 receives an entropy encoded (compressed) video bit stream and reverses the entropy coding to recover the encoded PUs and header information such as the prediction modes and the encoded CU structures of the LCUs, and the ALF filter types, filter coefficient set(s), and ALF enable maps. The inverse quantization component 402 de-quantizes the quantized transform coefficients of the residual PUs. The inverse transform component 404 transforms the frequency domain data from the inverse quantization component 402 back to residual PUs. That is, the inverse transform component 404 applies an inverse unit transform, i.e., the inverse of the unit transform used for encoding, to the de-quantized residual coefficients to produce the residual PUs.

A residual PU supplies one input of the addition component 406. The other input of the addition component 406 comes from the mode switch 408. When an inter-prediction mode is signaled in the encoded video stream, the mode switch 408 selects a PU from the motion compensation component 410 and when an intra-prediction mode is signaled, the mode switch selects a PU from the intra prediction component 414. The motion compensation component 410 receives reference data from storage 412 and applies the motion compensation computed by the encoder and transmitted in the encoded video bit stream to the reference data to generate a predicted PU.

The intra prediction component 414 receives reference data from previously decoded PUs of a current picture from the picture storage and applies the intra prediction computed by the encoder as signaled by the intra prediction mode transmitted in the encoded video bit stream to the reference data to generate a predicted PU.

The addition component 406 generates a decoded PU, by adding the selected predicted PU and the residual PU. The output of the addition component 406 supplies the input of the deblocking loop filter component 416. The deblocking loop filter component 416 smoothes artifacts created by the block nature of the encoding process to improve the visual quality of the decoded picture. The output of the deblocking loop filter component 416 is provided to the deblocked pixel storage component 418.

The adaptive loop filter component 420 performs LCU-based adaptive loop filtering on a deblocked decoded picture according to the ALF filter type, filter coefficients, and ALF enable map signaled by the encoder. The ALF application is LCU-based and is performed in the same manner as the LCU-based filter application in the encoder. A Laplacian-based local activity may be used to switch between the different filter coefficients on a block-by-block basis. The filter type set used by the adaptive loop filter component 420 is the same as that used by the adaptive loop filter component 342 of the encoder. The output of the adaptive loop filter component 420 is the decoded pictures of the video bit stream. Further, the output of the adaptive loop filter component 420 is stored in storage 412 to be used as reference data.

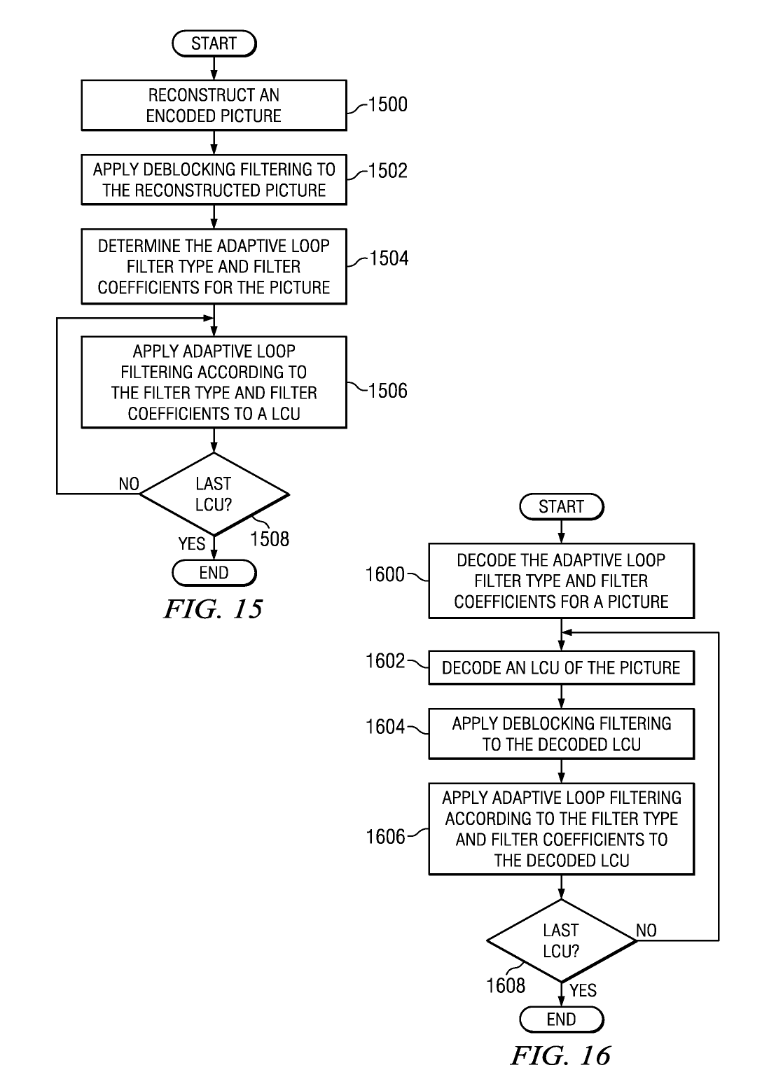

FIG. 15 shows a flow diagram of a method for adaptive loop filtering in a video encoder. Initially, an encoded picture is reconstructed 1500 in the embedded decoder of the video encoder. Deblocking filtering is then applied 1502 to the reconstructed picture. An adaptive loop filter type and one or more sets of filter coefficients for the adaptive loop filter type are then determined 1504 for the picture. The determination of the adaptive loop filter type and the set(s) of filter coefficients may be performed using any suitable technique. A predefined set of adaptive loop filter types may be used. Adaptive loop filtering is then applied 1506 to each LCU 1508 in the reconstructed picture according to the filter type and the set(s) of filter coefficients. While not specifically shown, an indication of the filter type and the set(s) of filter coefficients are encoded for communication to a decoder. In some embodiments, the predefined set may include only a single filter type. In such embodiments, there is no need to communicate the filter type to a decoder.

FIG. 16 shows a flow diagram of a method for adaptive loop filtering in a video decoder. Initially, an indication of the adaptive loop filter type and the set(s) of filter coefficients for a picture are decoded 1600. The indication of the adaptive loop filter type is used to select the filter type to be used for adaptive loop filtering from a predefined set of adaptive loop filter types. Adaptive loop filtering is then applied 1606 to each LCU 1608 of the picture according to the filter type and set(s) of filter coefficients after the LCU is decoded 1602 and deblocking filtering is applied 1604. In some embodiments, the predefined set of adaptive loop filter types contains only one filter type. In such embodiments, the indication of the filter type is not decoded and the filter type is not selected.

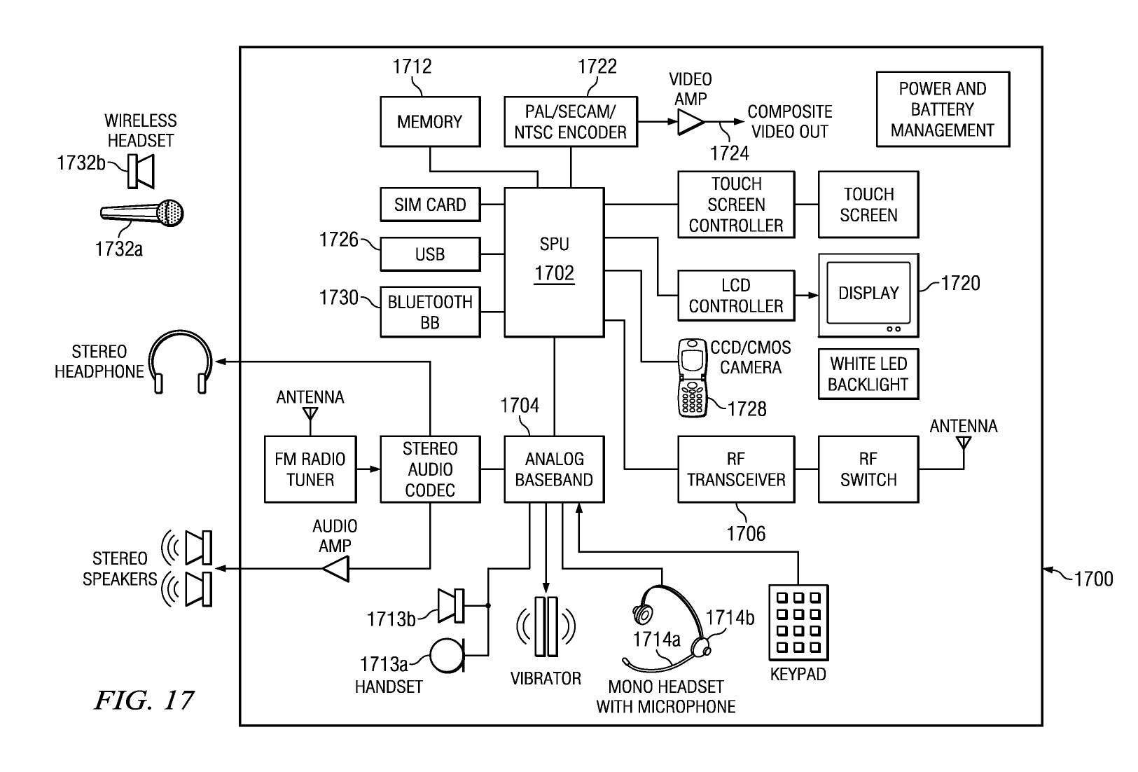

Embodiments of the methods, encoders, and decoders described herein may be implemented for virtually any type of digital system (e.g., a desk top computer, a laptop computer, a tablet computing device, a netbook computer, a handheld device such as a mobile (i.e., cellular) phone, a personal digital assistant, a digital camera, etc.). FIG. 17 is a block diagram of a digital system 1700 (e.g., a mobile cellular telephone) that may be configured to use techniques described herein.

As shown in FIG. 17, the signal processing unit (SPU) 1702 includes a digital signal processing system (DSP) that includes embedded memory and security features. The analog baseband unit 1704 receives a voice data stream from the handset microphone 1713a and sends a voice data stream to the handset mono speaker 1713b. The analog baseband unit 1704 also receives a voice data stream from the microphone 1714a or 1732a and sends a voice data stream to the mono headset 1714b or wireless headset 1732b. The analog baseband unit 1704 and the SPU 1702 may be separate ICs. In many embodiments, the analog baseband unit 1704 does not embed a programmable processor core, but performs processing based on configuration of audio paths, filters, gains, etc being setup by software running on the SPU 1702.

The display 1720 may display pictures and video sequences received from a local camera 1728, or from other sources such as the USB 1726 or the memory 1712. The SPU 1702 may also send a video sequence to the display 1720 that is received from various sources such as the cellular network via the RF transceiver 1706 or the Bluetooth interface 1730. The SPU 1702 may also send a video sequence to an external video display unit via the encoder unit 1722 over a composite output terminal 1724. The encoder unit 1722 may provide encoding according to PAL/SECAM/NTSC video standards.

The SPU 1702 includes functionality to perform the computational operations required for video encoding and decoding. In one or more embodiments, the SPU 1702 is configured to perform computational operations for applying one or more techniques for adaptive loop filtering during the encoding process as described herein. Software instructions implementing all or part of the techniques may be stored in the memory 1712 and executed by the SPU 1702, for example, as part of encoding video sequences captured by the local camera 1728. The SPU 1702 is also configured to perform computational operations for applying one or more techniques for adaptive loop filtering as described herein as part of decoding a received coded video sequence or decoding a coded video sequence stored in the memory 1712. Software instructions implementing all or part of the techniques may be stored in the memory 1712 and executed by the SPU 1702.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, in some embodiments, the filter type and filter coefficients may be changed on a slice basis within a picture.

In another example, in some embodiments, the order in which the adaptive filtering is applied to the LCUs may be something other than sequential order, i.e., left to right, top to bottom.

In another example, in some embodiments of the invention, a filter type may be a cross with a center shape the size of which is dependent on the aspect ratio of the cross. FIGS. 11-14 show examples of such filter types. Other filter types may include, for example, a 9×5 cross with a center 3×3 square, a 9×9 cross with a center 3×3 square, a 7×7 cross with a center 3×3 square, a 7×5 cross with a center 5×5 star, and a 7×7 cross with a center 5×5 star.

In another example, the filter types of FIGS. 13 and 14 may be included in larger predefined sets of filter types, such as a predefined set with two filter types or a predefined set with three filter types.

In another example, the same filter type(s) may be used for both luma and chroma components of a picture.

In another example, in some embodiments, the adaptive loop filter component in the decoder may not consider all filter types in the predefined set of filter types when selecting the filter type to be used.

In another example, in some embodiments, ALF filtering using the filter types described herein may be applied on a picture basis.

Embodiments of the methods, encoders, and decoders described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

It is therefore contemplated that the appended claims will cover any such modifications of the embodiments as fall within the true scope of the invention.

What is claimed is:

1. A method for decoding an encoded video bit stream in a video decoder, the method comprising:
decoding a plurality of sets of adaptive loop filter coefficients encoded in the video bit stream; and
decoding a picture encoded in the video bit stream, wherein adaptive loop filtering is applied to the decoded picture on a largest coding unit (LCU) by LCU basis according to an adaptive loop filter type used in encoding the picture and the plurality of sets of adaptive loop filter coefficients.

2. The method of claim 1, wherein a vertical size of the adaptive loop filter type is smaller than a horizontal size of the adaptive loop filter type.

3. The method of claim 1, wherein there is only one adaptive loop filter type.

4. The method of claim 3, wherein the one adaptive loop filter type is one selected from a group consisting of: a 9×7 cross with a 3×3 center square and a 9×7 cross with a 5×5 center star.

5. The method of claim 3, wherein the one adaptive loop filter type is a cross with a center shape of a size dependent on an aspect ratio of the cross.

6. The method of claim 1, wherein decoding a picture further comprises:
decoding a first LCU of the picture;
filtering the first LCU according to the adaptive loop filter type and the plurality of sets of adaptive loop filter coefficients;
decoding a second LCU of the picture; and
filtering the second LCU according to the adaptive loop filter type and the plurality of sets of adaptive loop filter coefficients, wherein the filtering the second LCU is performed after the filtering of the first LCU.

7. The method of claim 1, further comprising:
selecting the adaptive loop filter type from a predefined set of adaptive loop filter types, wherein a maximum vertical size of the adaptive loop filter types is less than a horizontal size of a largest adaptive loop filter type in the predefined set.

8. The method of claim 7, wherein the predefined set of adaptive loop filter types consists of two adaptive loop filter types, and wherein at least one of the adaptive loop filter types is a cross with a center shape of a size dependent on an aspect ratio of the cross.

9. The method of claim 8, wherein the cross with a center shape is one selected from a group consisting of a 9×7 cross with a 3×3 center square and a 9×7 cross with a 5×5 center star.

10. The method of claim 7, wherein the predefined set of adaptive loop filter types consists of three adaptive loop filter types.

11. The method of claim 8, wherein the three adaptive loop filter types are a 9×7 vertically flattened diamond, a 7×7 diamond, and a 5×5 diamond.

12. A method for decoding an encoded video bit stream in a video decoder, the method comprising:
decoding a plurality of sets of adaptive loop filter coefficients encoded in the video bit stream; and
decoding a picture encoded in the video bit stream, wherein adaptive loop filtering is applied to the decoded picture according to an adaptive loop filter type used in encoding the picture and the plurality of sets of adaptive loop filter coefficients, wherein there is only one adaptive loop filter type.

13. The method of claim 12, wherein the one adaptive loop filter type is a cross with a center shape of a size dependent on an aspect ratio of the cross.

14. The method of claim 13, wherein the cross with a center shape is one selected from a group consisting of a 9×7 cross with a 3×3 center square and a 9×7 cross with a 5×5 center star.

15. The method of 12, wherein a vertical size of the adaptive loop filter type is smaller than a horizontal size of the adaptive loop filter type.

16. The method of claim 12, wherein the adaptive loop filtering is applied on a largest coding unit (LCU) by LCU basis.

17. A method for decoding an encoded video bit stream in a video decoder, the method comprising:
decoding a plurality of sets of adaptive loop filter coefficients encoded in the video bit stream; and
decoding a picture encoded in the video bit stream, wherein adaptive loop filtering is applied to the decoded picture according to an adaptive loop filter type used in encoding the picture and the plurality of sets of adaptive loop filter coefficients, wherein a vertical size of the adaptive loop filter type is smaller than a horizontal size of the adaptive loop filter type.

18. The method of claim 17, wherein the adaptive loop filtering is applied on a largest coding unit (LCU) by LCU basis.

19. The method of claim 17, further comprising:
selecting the adaptive loop filter type from a predefined set of adaptive loop filter types, wherein a maximum vertical size of the adaptive loop filter types is less than a horizontal size of a largest adaptive loop filter type in the predefined set.

20. The method of claim 17, wherein the predefined set of adaptive loop filter types comprises at least two adaptive loop filter types, and wherein at least one of the adaptive loop filter types is a cross with a center shape of a size dependent on an aspect ratio of the cross.
